(19) United States
(12) Patent Application Publication
(10) Pub. No.: US 2024/0085701 A1
(43) Pub. Date: Mar. 14, 2024

(54) OPTICAL SYSTEM, VIRTUAL IMAGE DISPLAY DEVICE, AND HEAD-MOUNTED DISPLAY

(71) Applicants: Takemasa TSUTSUI, Kanagawa (JP); Yoshifumi SUDOH, Kanagawa (JP)

(72) Inventors: Takemasa TSUTSUI, Kanagawa (JP); Yoshifumi SUDOH, Kanagawa (JP)

(21) Appl. No.: 18/243,671

(22) Filed: Sep. 8, 2023

(30) Foreign Application Priority Data
Sep. 12, 2022 (JP) 2022-144262

(51) Int. Cl. G02B 27/01

(52) U.S. Cl. CPC G02B 27/0172; G02B 2027/0118; G02B 2027/0145; G02B 2027/0178

(57) ABSTRACT

An optical system for a virtual display device includes: a light guide; a partial reflector to: transmit first image light guided in a first direction from a first side of the partial reflector through the light guide; and reflect second image light to exit outside the light guide, the second image light guided in a second direction, different from the first direction, from a second side different from the first side through the light guide; a reflector at the second side of the partial; and a polarizer. The polarizer rotates a polarization of the first image light polarized in a first polarization direction; and rotates a polarization of the second image light to polarize the second image light in a second polarization direction. The partial reflector has a lower reflectance for light polarized in the first polarization direction than for light polarized in the second polarization direction.

### CROSS-REFERENCE TO RELATED APPLICATIONS

This patent application is based on and claims priority pursuant to 35 U.S.C. § 119(a) to Japanese Patent Application No. 2022-144262, filed on Sep. 12, 2022, in the Japan Patent Office, the entire disclosure of which is hereby incorporated by reference herein.

### BACKGROUND

### Technical Field

Embodiments of the present disclosure relate to an optical system, a virtual image display device, and a head-mounted display.

### Related Art

Virtual image display devices have been developed for displaying an enlarged two-dimensional virtual image to an observer.

A typical virtual image display device is, for example, a glass device with an image display element embedded in its frame. The virtual image display device, for example, allows light (i.e., image light, or light containing image information) emitted from the image display element to proceed in a lens. In the lens, the image light passes through the partial reflection surface, reflects off the reflection surface, and returns to the partial reflection surface, reflecting off toward the observer. Thus, the observer can observe the image light as an enlarged virtual image.

In such a typical image display device, however, when the image light passes through the partial reflection surface, a large amount of light reflects off the partial reflection surface. Since a large amount of image light reflects off the partial reflection surface and leaks outwards, it is pointed out that the light utilization efficiency may be compromised.

### SUMMARY

An embodiment of the present disclosure provides an optical system including: a light guide to guide image light emitted from an image display element that displays an image; a partial reflector to: transmit first image light guided in a first direction from a first side of the partial reflector through the light guide; and reflect second image light to exit outside the light guide, the second image light guided in a second direction, different from the first direction, from a second side different from the first side through the light guide; a reflector at the second side of the partial reflector to reflect the first image light transmitted through the partial reflector in the first direction, back to the partial reflector as the second image light in the second direction; and a polarizer between the partial reflector and the reflector. The polarizer rotates a polarization of the first image light polarized in a first polarization direction, the first image light transmitted through the partial reflector in the first direction; and rotates a polarization of the second image light reflected back from the reflector to polarize the second image light in a second polarization direction. The partial reflector has a lower reflectance for light polarized in the first polarization direction than for light polarized in the second polarization direction.

An embodiment of the present disclosure provides a virtual image display device including the optical system described above, and the image display element.

An embodiment of the present disclosure provides a head-mounted display including the virtual image display device described above.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram of a head-mounted display incorporating a virtual display device according to an embodiment of the present disclosure;

FIG. 2 is a schematic diagram of a virtual image display device according to an embodiment of the present disclosure;

FIG. 3A, FIG. 3B, and FIG. 3C are ray diagrams for describing the reason why the thickness of a light guided can be reduced by forming, within the light guide, an intermediate image with image light from an image display element, according to an embodiment of the present disclosure;

FIG. 4A illustrates an optical configuration of a virtual image display device according to Numerical Example 1;

FIG. 4B illustrates an optical configuration of the virtual image display device according to Numerical Example 1;

FIG. 5 is a diagram of the illuminance distribution on the wearer's retina in Numerical Example 1;

FIG. 6 is a graph of light shielding ratios in Numerical Example 1;

FIG. 7 is a diagram of the illuminance distribution on the wearer's retina in Numerical Example 2;

FIG. 8 is a graph of a light shielding ratio in Numerical Example 2;

FIG. 9A illustrates an optical configuration of a virtual image display device according to Numerical Example 3;

FIG. 9B illustrates an optical configuration of a virtual image display device according to Numerical Example 3;

FIG. 10 is a diagram of the illuminance distribution on the wearer's retina in Numerical Example 3;

FIG. 11 is a graph of a light shielding ratio in Numerical Example 3;

FIG. 12A illustrates an optical configuration of a virtual image display device according to Numerical Example 4;

FIG. 12B illustrates an optical configuration of a virtual image display device according to Numerical Example 4;

FIG. 13 is a diagram of the illuminance distribution on the wearer's retina in Numerical Example 4; and

FIG. 14 is a graph of a light shielding ratio in Numerical Example 4.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An embodiment of the present disclosure provides an optical system that achieves enhanced light utilization efficiency; a virtual display device incorporating the optical system; and a head-mounted display incorporating the optical system.

An optical system for a virtual image display device according to an embodiment, a virtual image display device, and a head-mounted display are described below with reference to the drawings. In the following description, common or corresponding elements are denoted by the same or similar reference signs, and redundant description is appropriately simplified or omitted.

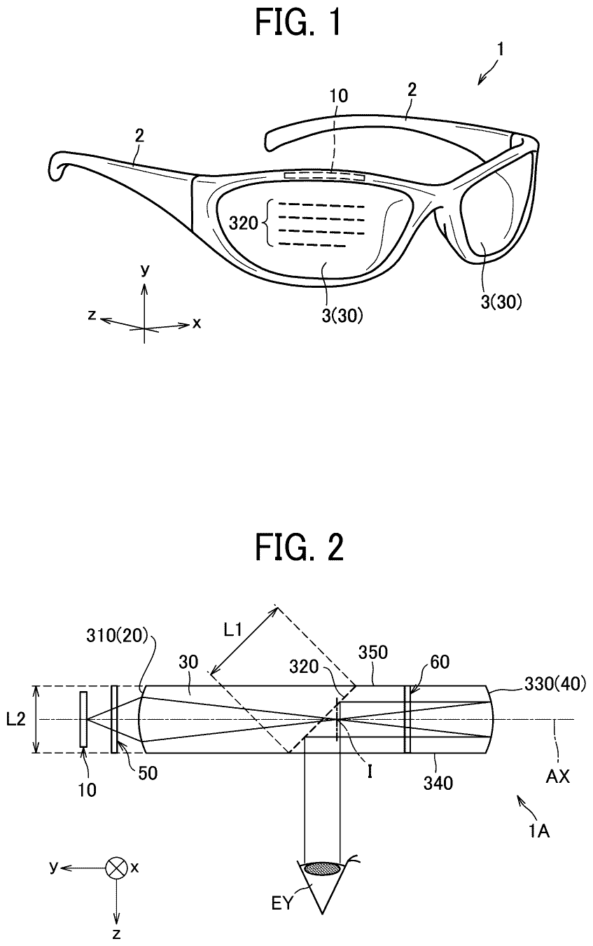

FIG. 1 is a schematic diagram of a head-mounted display 1 incorporating a virtual display device according to an embodiment of the present disclosure. In the present embodiment, a head-mounted display 1 is, for example, smartglasses that serve as a glasses-type wearable terminal. The smartglasses may be referred to as a glass device or a glass display.

Examples of the head-mounted display 1 include a virtual reality (VR) glasses, augmented reality (AR) Glasses, mixed reality (MR) Glasses, extended reality (XR) glasses, which are all wearable terminals.

In FIG. 1, the head-mounted display 1 is a binocular head-mounted display. In another embodiment, the head-mounted display 1 may be a monocular head-mounted display corresponding to one of the left and right eyes.

As illustrated in FIG. 1, the head-mounted display 1 includes a frame portion 2 and a lens portion 3. The lens portion 3 is fitted into the frame portion 2. A pair of lens portions 3 is disposed corresponding to the left and right eyes of the wearer.

An image display element 10 for displaying an image is built in the frame portion 2. In FIG. 1, the image display element 10 is embedded in a portion of the frame portion 2 covering the upper edge of the lens portion 3. The installation position of the image display element 10 is not limited to the position illustrated in FIG. 1. Alternatively, the image display element 10 may be embedded in a portion of the frame portion 2 covering the lower edge of the lens portion 3.

The image display element 10 displays an image to be recognized as a virtual image. Examples of the image display element 10 include an organic light emitting diode (OLED) array, a laser diode (LD) array, a light emitting diode (LED) array, micro electro mechanical systems (MEMS), and a digital micromirror device (DMD).

In the following description, a z-direction in FIG. 1 is referred to as a first horizontal direction from the lens portion 3 to the eyes of the wearer (a user), an x-direction in FIG. 1 is referred to as a second horizontal direction orthogonal to the z-direction, and a y-direction in FIG. 1 is referred to as a vertical direction orthogonal to each of the x-direction and the z-direction. The x-direction, the y-direction, and the z-direction orthogonal to each other form a left-handed system.

The term “direction” is used for convenience to describe the relative position between the components, and does not indicate an absolute direction. Depending on the posture of the user wearing the head-mounted display 1, for example, the z-direction may not be the horizontal direction and may be the vertical direction.

Light rays (i.e., image light) emitted from the respective pixels of the image display element 10 are emitted from the image display element 10 in the −y-direction to enter the lens portions 3 and proceed through the lens portions 3. Thereafter, the light rays are emitted from the lens portions 3 in the +z-direction (i.e., to the eyes of the wearer) for display of a virtual image. In other words, the pair of lens portions 3 each forms an eye box in a region including the corresponding eye.

FIG. 2 is a schematic diagram of a virtual image display device 1A according to an embodiment of the present disclosure. FIG. 2A is an illustration of a yz cross section (a cross-sectional plane including the optical axis AX) of the image display element 10 and one lens portion 3.

In the present embodiment, the optical axis AX is defined as an optical path of light proceeding from the center of the effective pixel area of the image display element 10 in a direction perpendicular to the pixel array surface. The optical axis AX is also an optical axis of the virtual image display device 1A, and is also an optical axis of each of optical components (for example, the light guide 30) included in the optical system for the virtual image display device 1A.

The virtual image display device 1A is, for example, mounted on the head-mounted display 1.

The virtual image display device 1A according to the present embodiment may be mounted on a device of other forms other than a head-mounted display. For example, the virtual image display device 1A may be mounted on a head-up display.

The virtual image display device 1A includes an image display element 10 and an optical system for the virtual image display device. In the schematic diagram of FIG. 2, the virtual image display device 1A includes an image display element 10, an intermediate image former 20, a light guide 30, a reflector 40, and polarizing plates 50 and 60. In FIG. 2A, one eye EY of the left and right eyes of the wearer is illustrated.

The light guide 30 is an optical component that guides image light from the image display element 10. In the virtual image display device 1A mounted on the head-mounted display 1, the lens portion 3 corresponds to the light guide 30.

The light guide 30 has a first face 310 (incident surface) on which the image light from the image display element 10 strikes. In the light guide 30, a partial reflector 320 is disposed to split the image light entered through the first face 310 of the light guide 30, into reflected light and transmitted light.

The partial reflector 320 transmits a part (some rays) of image light guided in the −y-direction within the light guide 30 (i.e., the first-direction image light guided in a first direction from the image display element 10 in the light guide 30, or guided from the first side of the partial reflector 320, in which the image display element 10 is positioned. The partial reflector 320 reflects, in the +z-direction, a part (some rays) of image light guided in the +y-direction within the light guide 30 (i.e., the second-direction image light guided in a second direction different from the first direction, or guided from the second side that is different from the first side within the light guide 30), causing the reflected light to exit externally through the third face 340 of the light guide 30.

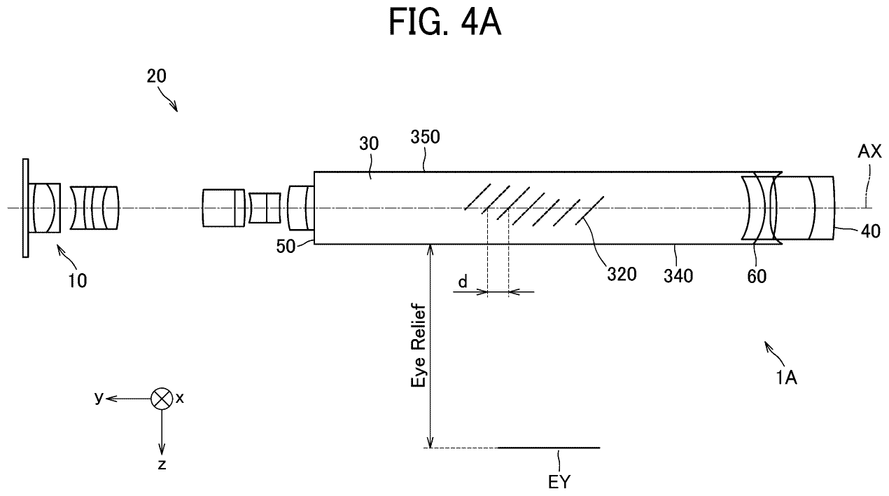

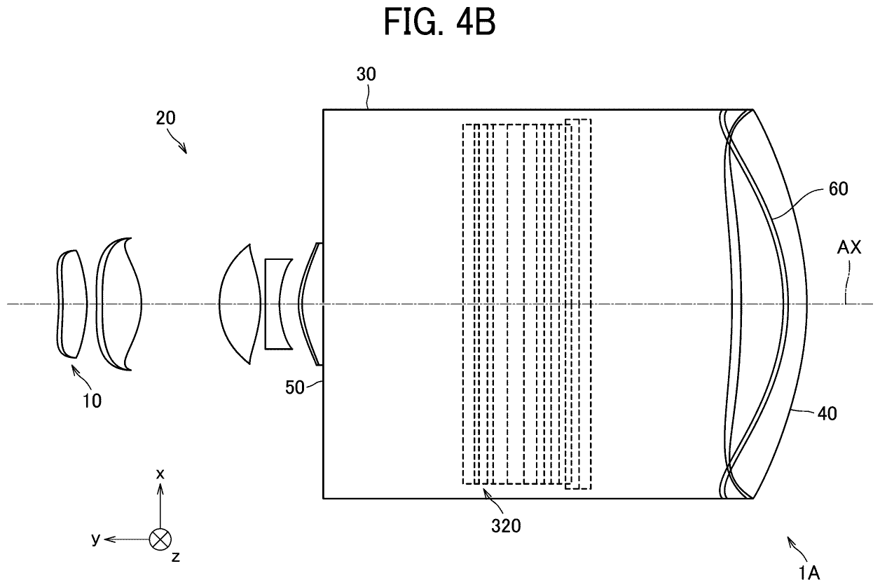

As indicated in Numerical Examples 1 to 4 to be described later, multiple partial reflectors 320 are arranged at an interval d between adjacent partial reflectors 320 along the optical axis AX within the light guide 30. In other words, the interval between two adjacent partial reflectors 320 on the optical axis AX may be an interval d (see FIG. 4A, which is described below).

The image light is split into multiple light beams by the multiple partial reflectors 320, so that the eye box is enlarged and the angle of view is also enlarged. This allows the wear to visually identify or perceive the virtual image easily and also a virtual image with a wide angle of view, irrespective of the movement of the eye EY relative to the virtual image display device 1A.

The interval d satisfies, for example, conditional expression (1) below in order to obtain an eye box appropriate to achieve the intended performance.

0.5 mm<d<3.0 mm (1)

When the interval d is 0.5 mm or less, for example, non-uniformity in light amount (or non-uniformity in the luminance of a virtual image) becomes more likely. This is due to image light being reflected off one partial reflector 320 and then further reflected off an adjacent partial reflector 320.

The numerous partial reflectors 320 may interfere with the wearer's field of view, potentially obstructing, for instance, the wearer's view of the external scenery. At the interval d of 3.0 mm or greater, the virtual image appears partially missing depending on a location within the eye box, which is caused by an excessively increased interval d.

The interval d between adjacent partial reflectors of the multiple partial reflectors 320 may be equal, or it doesn't have necessarily have to be so.

The partial reflector 320 is oriented to allow the image light to form a predetermined angle (e.g., an angle of 45 degrees) relative to the optical axis AX (or the third face 340 from which the image light is emitted in the +z-direction). The partial reflector 320 is, for example, a semi-reflective mirror. The partial reflector 320 may be a polarizing beam splitter (PBS).

The partial reflector 320 is formed of, for example, a partial reflection surface formed in a plane. Such a configuration with the partial reflector 320 formed in a plane increases ease of manufacture and facilitates aberration correction.

In a case in which the light guide 30 includes multiple partial reflectors 320 each having a non-flat surface (e.g., a surface having a curvature), the following issues are raised. In this configuration, adjacent partial reflectors 320 are formed in different shapes to display a high-resolution virtual image with aberrations successfully corrected.

In order to correct aberrations successfully, the aberration correction is shared by the partial reflectors 320 and an optical system (one or more optical components) closer to the image display element 10 than the partial reflectors 320 along the optical path of the image light.

To achieve such a performance, each of the multiple partial reflectors 320 has a shape with a different free-form surface. This structure makes it difficult to obtain ease of manufacture and to correct aberrations.

In FIG. 2, the light guide 30 includes multiple optical blocks (a first optical block and a second block). The first optical block has a partial reflection surface (i.e., a partial reflector 320) formed on its inclined surface. The inclined surface on which the partial reflection surface is formed in the first optical block is bonded to the inclined surface of the second optical block (on which the partial reflection surface is not formed). This completes the light guide 30.

Each of the partial reflection surfaces is formed of a deposited film formed by depositing a metal material, for example. To increase the degree of adhesion between the optical blocks, a primer layer may be formed on the inclined surface of the optical block before forming the partial reflection surface on the primer layer.

Each optical block of the light guide 30 is a molded product made of synthetic resin such as plastic. The light guide 30 made of such resin is lightweight. With a decrease in the weight of the light guide 30, the load on the nose of the wearer (the user) decreases. For this reason, the wearer can continue wearing the head-mounted display 1 for a long time without getting fatigued.

The virtual image display device 1A includes an intermediate image former 20 that forms an intermediate image I formed with the image light from the image display element 10 in the light guide 30.

In FIG. 2, the first face 310 of the light guide 30 is formed as a spherical surface or an aspherical surface, which forms an intermediate image former 20 that forms the intermediate image I of the image light from the image display element 10 in the light guide 30 (for example, in the vicinity of the partial reflector 320). The first face 310 serving also as the intermediate image former 20 enables a smaller virtual image display device 1A and lower manufacturing cost.

Alternatively, the virtual image display device 1A may include a propagation optical system in the optical path of the image light traveling from the image display element 10 to the light guide 30, to transmit the image light from the image display element 10 to the light guide as in Numerical Example 1 to Numerical Example 4 below. In this case, for example, the propagation optical system serves as the intermediate image former 20. This allows the propagation optical system to correct aberrations, enabling successful correction of various types of aberrations.

The virtual image display device 1A includes a reflector 40. The reflector 40 is at one side (a second side, or the opposite side of a first side of the partial reflectors 320 in FIG. 2) of the partial reflector 320, which is different from another side (the first side of the partial reflector 320, at which the image display element 10 is positioned in FIG. 2). In the virtual image display device 1A mounted on the head-mounted display 1, the reflector 40 is positioned at a lower frame portion below the lens portion 3, facing the image display element 10 in an upper frame portion above the lens portion 3.

The image light entered through the first face 310 and transmitted through the partial reflector 320 is guided to the reflector 40. The reflector 40 has a reflecting surface. The image light guided to the reflector 40 is reflected by the reflecting surface of the reflector 40 toward the partial reflector 320 in the z-direction. The reflecting surface may be flat and have power.

The reflector 40 reflects the first-direction image light (i.e., image light guided in the −y-direction) transmitted through the partial reflector 320 as the second-direction image light (i.e., image light guided in the +y-direction) toward the partial reflector 320.

The reflector 40 (i.e., the reflecting surface in FIG. 2) has positive power. The reflector 40 converts the image light incident through the partial reflector 320 into collimated light or substantially collimated light, reflecting the collimated light (or substantially collimated light) toward the partial reflector 320.

As a result, the collimated light or substantially collimated light is guided to proceed in the +y-direction in the light guide 30, reflecting off the partial reflector 320 in the +z-direction. Thus, the reflected light exits externally through the third face 340 of the light guide 30, reaching the eyes EY of the wearer.

For the collimated light, the wearer can successfully perceive a virtual image at infinite virtual distance. For the substantially collimated light, the wearer can successfully perceive a virtual image at an appropriate virtual-image distance (i.e., the distance between the eyes EY and a plane onto which the virtual image is formed). The virtual-image distance may be changed as appropriate for the use of the virtual image display device 1A.

The light guide 30 includes a second face 330, which is opposite to the first surface with the partial reflector 320 between the first face 310 and the second face 330. In FIG. 2, the second face 330 is a reflecting surface serving as the reflector 40. The second face 330 serving as the reflector 40 enables a smaller virtual image display device 1A and lower manufacturing cost.

The virtual image display device 1A may include another optical component separate from the light guide 30 in the optical path of the image light subsequent to the light guide 30 as in Numerical Examples 1 to 3 below. In this case, for example, said another optical component constitutes the reflector 40 including the reflecting surface.

The reflector 40 converts the image light transmitted through the partial reflector 320 and emitted from the second face 330 into collimated light or substantially collimated light, reflecting the collimated light or substantially collimated light toward the partial reflector 320.

As a result, the collimated light or substantially collimated light is incident into the light guide 30 from the second face 330 and guided in the +y-direction, reflecting off the partial reflector 320 in the +z-direction. Then, the reflected light exits the light guide 30 through the third face 340, reaching the eye EY of the wearer.

This configuration causes the reflector 40 that is another optical component separate from the light guide 30 to correct aberrations and thus allows successful correction of various aberrations.

In the virtual image display device 1A according to the present embodiment, the intermediate image former 20 forms the intermediate image I with the image light emitted from the image display element 10 in the light guide 30. This reduces the thickness of the light guide (in other words, the size of the light guide 30 is reduced in the z-direction). The light guide made of such resin is lightweight. With a decrease in the weight of the light guide 30, the load on the nose of the wearer (the user) decreases. For this reason, the wearer can continue wearing the head-mounted display 1 for a long time without getting fatigued.

Further, forming an intermediate image I with the image light emitted from the image display element 10 in the light guide 30 allows the pupil of the optical system for the virtual image display device to be in the vicinity of the eye EY of the wearer. This allows for a wider eye box as well as a wider angle of view.

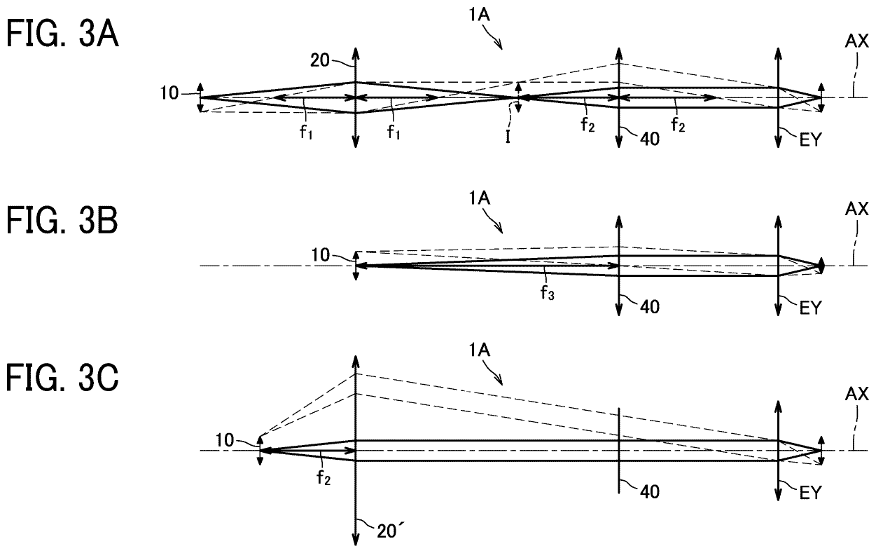

The following describes the reason why the light guide 30 can be made thinner by forming the intermediate image I with the image light emitted from the image display element within the light guide 30 with reference to FIGS. 3A, 3B and 3C.

FIG. 3A is a ray diagram of the virtual image display device 1A according to an embodiment of the present disclosure, in which the intermediate image I has a magnification of 1×. In FIG. 3A, f₁ represents the focal distance of the intermediate image forming portion 20, and f₂ represents the focal distance of the reflector 40. FIG. 3B is a ray diagram of a virtual image display device in which the use of the intermediate image forming portion 20 is omitted from the virtual image display device 1A according to an embodiment of the present disclosure.

In FIG. 3B, f₃ indicates the focal distance of the reflector 40.

FIG. 3C is a ray diagram of a virtual image display device including a propagation optical system 20′ instead of the intermediate image forming portion 20 in the virtual image display device 1A according to an embodiment of the present disclosure. The propagation optical system 20′ converts the image light from the image display element 10 into collimated light and emits the collimated light toward the light guide 30.

In FIG. 3C, the reflector 40 is a reflecting surface (or plane) having no refractive power. The angle of view in FIG. 3C is the same as that of FIG. 3A.

In FIGS. 3A to 3C, an axial light beam is indicated by a solid line, and an off-axis light beam is indicated by a broken line. The size of the display image displayed by the image display element 10 is indicated by arrows at the position of the image display element 10. The size is the same between FIGS. 3A, 3B, and 3C.

In order to allow the wearer to see the scenery and the video of the external world, the distance between the reflector 40 (i.e., the reflecting surface) and the image display element 10 or the intermediate image forming portion 20 is provided sufficiently to achieve the intended performance.

In FIG. 3A, the distance between the intermediate image forming portion 20 and the reflector 40 corresponds to the width of the lens portion 3 in the vertical direction (i.e., the y-direction) in FIG. 1. This is because the width of the lens portion 3 in the vertical direction is to be set wide so that the wearer can see the scenery of the outside world.

Similarly, in FIG. 3B, the distance between the image display element 10 and the reflector 40, which corresponds to the width of the lens portion 3 in the vertical direction, is to set wide.

Similarly, in FIG. 3C, the distance between the propagation optical system 20′ and the reflector 40, which corresponds to the width of the lens portion 3 in the vertical direction, is to set wide. In FIG. 3B in which the virtual-image distance between the eyes EY and a plane onto which the virtual image is formed is set to infinity, the focal distance f₃ is increased to cause the axial light beam and the off-axial light beam to proceed in the thin light guide 30.

More specifically, the focal distance f₃ in FIG. 3B is set so as to correspond to the distance between the image display element 10 and the reflector 40 described above. The image light is collimated by the reflector 40 to allow the wearer to visually identify the virtual image.

As described above, the focal distance f₃ is limited by the width of the lens portion 3. For this reason, it is impossible to shorten the focal distance f₃. The configuration in FIG. 3B fails to obtain a wider angle of view.

In the configuration of FIG. 3B, in order to obtain the angle of view equivalent to that of FIG. 3A, the size of the image display element 10 is to be increased. This, however, increases the size of the virtual image display device itself.

In FIG. 3C in which the virtual-image distance between the eyes EY and a plane onto which the virtual image is formed is set to infinity, the thickness of the light guide 30 is increased in order to obtain the same angle of view as in FIG. 3A (i.e., so that the light guide 30 can also guide an off-axis light beam used for forming a wide angle of view).

More specifically, the propagation optical system 20′ in FIG. 3C is to be increased in a direction perpendicular to the optical axis AX (the up-to-down direction in the drawing) so as to allow the off-axial rays (indicated by the broken line in FIG. 3C) from the image display element 10 to proceed through the propagation optical system 20′. To further allow the image light emitted from the propagation optical system 20′ to proceed in the light guide 30, the thickness of the light guide 30 is increased up-to-down direction in FIG. 3C.

In the virtual image display device 1A according to an embodiment of the present disclosure in FIG. 3A, the intermediate image I is formed at a position closer to the reflector 40 (more specifically, the reflecting surface of the reflector 40) in the light guide 30 so that the focal length f₂ can be shortened. This enables a wider angle of view and a thinner light guide 30. In other words, the light guide 30 with its thickness reduced can also guide or allows an off-axis light beam to proceed therein for a wider angle of view.

The following describes a specific configuration of the virtual image display device 1A according to the present embodiment.

Upon reaching the partial reflector 320, the first-direction image light (the image light guided in the −y-direction within the light guide 30) partially passes through the partial reflector 320, directed toward the reflector 40 while the remaining portion reflects off the partial reflector 320, exiting externally through the face 350 opposed to the third face 340. In order to reduce the amount of image light leaking outward, the transmittance of the partial reflector 320 is to be increased (i.e., the reflectance of the partial reflectors 320 is to be reduced). However, if the transmittance of the partial reflector 320 is increased, most of the second-direction image light (i.e., the image light guided in the +y-direction within the light guide 30) passes through the partial reflector 320. This means that less image light is reflected in the +z-direction at the partial reflector 320 and directed toward the eye EY of the wearer. In the present embodiment, the virtual image display device 1A further includes the polarizing plates 50 and 60 to enhance the light utilization efficiency.

The polarizing plate 50 is located between the image display element 10 and the partial reflector 320. The polarizing plate 50 converts the image light traveling in the first direction from the image display element toward the partial reflector 320 (i.e., image light from the first side of the partial reflector 320, in which the image display element 10 is positioned) toward the partial reflector 320 into image light in a first polarization direction. When multiple partial reflectors 320 are used, the polarizing plate 50 is located between the image display element 10 and a partial reflector 320 closest to the image display element 10 among the multiple partial reflectors 320.

The polarizing plate 50, for example, is located between the image display element 10 and the light guide 30, and converts the image light traveling toward the partial reflectors 320 into P-polarized light serving as light polarized in the first polarization direction.

The polarizing plate 50 may be replaced with a polarizing film that converts the image light traveling from the first side of the partial reflector, at which the image display element 10 is positioned, toward the partial reflector 32, into the image light in the first polarization direction. In other words, the polarizing film converts the image light traveling in a first direction from the image display element 10 toward the partial reflector 320, into the image light in the first polarization direction, The polarizing film is formed on a surface of any optical element disposed between the image display element 10 and the partial reflector 320. The polarizing film (50) is formed on the first face 310 of the light guide 30, for example, and converts the image light traveling toward the partial reflector 320 into P-polarized light.

When forming the polarizing film (50) on the surface of the optical element, the polarizing plate 50 is not used. This allows for a reduction in the number of components of the virtual image display device 1A.

The partial reflector 320 has a lower reflectance for P-polarization that serves as the light polarized in the first polarization direction than for S-polarized light that serves as light polarized in a second polarization direction. The image light converted into P-polarized light by the polarizing plate 50 primarily passes through the partial reflector 320 and exhibits a low amount of reflection at the partial reflector 320. The amount of image light that reflects from the partial reflector 320 and leaks to the outside from the face 350 is reduced by the reflectance of the partial reflector 320 as described above.

The polarizing plate 60 is located between the partial reflector 320 and the reflector 40 (more specifically, the reflecting surface included in the reflector 40). The polarizing plate 60 rotates the polarization of the first-direction image light (the image light guided in the first direction) transmitted through the partial reflector 320 and further rotates the polarization of the second-direction image light (the image light guided in the second direction) reflected off the reflector 40. Thus, the image light polarized in the first polarization direction (i.e., the P-polarized image light) when passing through the partial reflector 320 is rotated to image light polarized in the second polarization direction (i.e., S-polarized light).

More specifically, the polarizing plate 60 is a quarter-wave plate. The P-polarized image light transmitted through the partial reflector 320 has its polarization direction rotated by degrees by the polarizing plate 60. Such P-polarized image light reflects off the reflector 40 and returns to the polarizing plate 60. The image light is further rotated by 45 degrees by the polarizing plate 60, becoming S-polarized light. The S-polarized light reaches the partial reflector 320.

The partial reflector 320 has a higher reflectance for S-polarization that serves as the light polarized in the second polarization direction than for P-polarized light that serves as light polarized in the first polarization direction. The image light converted into S-polarized light by the polarizing plate 60 primarily reflects off the partial reflector 320 without passing therethrough and exits externally from the third face 340 of the light guide 30. Thus, the image light reaches the eye EY of the wearer.

As described above, the virtual image display device 1A according to the present embodiment allows a reduction in the amount of the image light that leaks to the outside of the light guide after reflecting off the partial reflector 320 and enables more image light to reach the eye EY.

Thus, the virtual image display device 1A according to the present embodiment achieves high light utilization efficiency.

The partial reflector 320 is located within the field of view of the wearer. When the partial reflector 320 has a high reflectance, maintaining see-through properties becomes a challenge. However, since the external light is unpolarized and the partial reflector 320 has a high transmittance for p-polarized light, the present embodiment maintains the see-through properties.

As described above, since the partial reflector 320 is unlikely to block the field of view of the wearer, a larger partial reflector 320 can be easily incorporated in the light guide 30. Such a larger partial reflector 320 facilitates guiding of image light having a wide light flux width to the eye EY. The virtual image display device 1A with such a configuration can enhance image quality.

The following is a consideration for the case where multiple partial reflectors 320 are incorporated in the light guide 30. In this case, any one of multiple partial reflectors 320 is referred to as a first partial reflector, and any one of the remaining partial reflectors 320, which is positioned farther than the first partial reflector 320 from the polarizing plate 60 serving as a polarizer on the optical path, is referred to a second partial reflector 320. The virtual image display device 1A may satisfy the following conditional expression R1<R2, where R1 is a reflectance of the first partial reflector for the light polarized in the second polarization direction, and R2 is a reflectance of the second partial reflector for the light polarized in the second polarization direction.

A partial reflector 320 at a position farther from the polarizing plate 60 on the optical path receives less incident light. This is because, with each passage of the incident light through a preceding partial reflector 320 (i.e., a partial reflector 320 closer to the polarizing plate 60), the intensity of the light diminishes. In this configuration, if all of the multiple partial reflectors 320 have the same reflectance, the amount of light within the angle of view that is reflected off a partial reflector 320 positioned farther from the polarizing plate 60 on the optical path, and heads toward the eye EY, is more likely to have undergone attenuation, potentially leading to variations in light intensity. To avoid such a situation, differences in light intensity across different angles of view can be reduced by setting the reflectance of the partial reflectors 320. Thus, variations in light intensity can be reduced.

In order to maintain the see-through properties and light utilization efficiency, the partial reflector 320 may have a reflectance Rs of 5% or more and 50% or less for the second polarization direction.

If the reflectance Rs is less than 5%, the light utilization efficiency becomes too low, making it difficult to maintain the amount of image light reaching the eye EY. If the reflectance Rs exceeds 50%, the amount of external light reflected by the partial reflector 320 increases too much, making it difficult to prevent a decrease in see-through property.

In order to reduce the amount of image light that leaks to the outside from the face 350, the partial reflector 320 may have a reflectance Rp of 25% or less for the first polarization direction.

If the reflectance Rp exceeds 25%, the high amount of light reflected at the partial reflector 320 makes it difficult to reduce the amount of image light that leaks to the outside from the face 350.

As illustrated in FIG. 2, the partial reflector 320 has a side of length L1 along the side face of the light guide 30. The light guide 30 has a thickness L2, which is the length of the side face of the light guide 30 in the lateral direction (i.e., the z-direction in FIG. 2) orthogonal to the longitudinal direction of the light guide 30. The length L1 may be 0.3 times or more and 1.5 times or less than the length L2 in order to maintain the see-through property and a high-quality image.

If the length L1 is less than 0.3 times length L2, image light is less likely to reach the eye EY, potentially causing a partial virtual image depending on a position within the eye box. If the length L1 exceeds 1.5 times the length L2, the partial reflector 320 entering the field of view is excessively large, making it difficult to maintain the see-through property.

Numerical Example 1 to Numerical Example 4 of the virtual image display device 1A will be described. In Numerical Example 1 to Numerical Example 4 below, for convenience, the optical axis AX is parallel to the z-direction, and two directions orthogonal to the optical axis AX are the x-direction and the y-direction. In the virtual image display device 1A mounted on a head-mounted display 1, the x-direction is coincident with the width direction of the lens portions 3. The y-direction is orthogonal to the optical axis AX and the width direction of the lens portion 3. When the optical path is bent by 90 degrees by the partial reflector 320, the direction of the optical axis AX is also changed by 90 degrees, so that the xyz coordinate system is also rotated by 90 degrees.

### Numerical Example 1

FIGS. 4A and 4B illustrate the optical configuration of the virtual image display device 1A according to Numerical Example 1. FIG. 4A indicates a yz cross-sectional plane of the virtual image display device 1A. FIG. 4B indicates an xy cross-sectional plane of the virtual image display device 1A. The yz cross-sectional plane in FIG. 4A and the xy cross-sectional plane in FIG. 4B are based on sections when the optical axis AX, directed toward the eye EY of the wearer, aligns with the z-direction.

The virtual image display device 1A according to Numerical Example 1 includes a propagation optical system as the intermediate image former 20. The polarizing plate 50 is disposed in front of the light guide 30. The light guide 30 has a thickness of 5.5 mm. In the light guide 30, seven partial reflectors 320 formed in a planar shape are arranged at intervals d of 1.6 mm. A quarter-wave plate serving as the polarizing plate 60 is disposed behind the light guide 30. FIGS. 4A and 4B, the optical element surface located furthest in the —Y-direction is the reflecting surface of the reflector 40.

In Numerical Example 1, the angles of view of the virtual image in the vertical direction, the horizontal direction, and the diagonal direction are 20.0 degrees, 35.4 degrees, and 40.0 degrees, respectively. The distance to the virtual image is infinite. The aperture stop has a rectangular aperture with a length of 1.5 mm in the vertical direction and a length of 6.9 mm in the horizontal direction.

In Numerical Example 1, the side lengths L1 of the partial reflectors 320 are 3 mm, 3 mm, 3 mm, 3.5 mm, 3.5 mm, 3 mm, and 3 mm, respectively, in order from a partial reflector 320 closest to the polarizing plate 60 among the partial reflectors 320.

In Numerical Example 1, the reflectance for the P-polarized light (the light polarized in the first polarization direction) of the partial reflectors 320 are 1%, 1%, 2%, 2%, 4%, 6%, and 20% in order from the partial reflector 320 closest to the polarizing plate 60 among the partial reflectors 320.

In Numerical Example 1, the reflectance for the S-polarized light (the light polarized in the second polarization direction) of the partial reflectors 320 are 11%, 12%, 18%, 23%, 32%, 46%, and 88% in order from the partial reflector 320 closest to the polarizing plate 60 among the partial reflectors 320.

Table 1 presents a specific numerical configuration of the virtual image display device 1A according to Numerical Example 1. In Table 1, Ry is a radius of curvature (or a paraxial radius of curvature) (mm) of each surface of the optical elements in the y-direction (i.e., the y-axis orthogonal to the optical axis AX), and Rx is a radius of curvature (or a paraxial radius of curvature) (mm) of each surface of the optical elements in the x-direction (the x-axis orthogonal to the optical axis AX). Further, D is the thickness of each optical element on the optical axis AX or the distance between the optical elements on the optical axis AX, Nd is a refractive index for the d-line (a wavelength of 587.562 nm), and vd is an Abbe number of the d-line. The right column of the Abbe number in the Table 1 presents the product name and manufacturer of the material of the optical element.

The numbers in the Table are assigned to the respective surfaces of the virtual image display device 1A in order from the image display element 10. In Table 1, number 0 indicates an image display surface (i.e., pixel array surface) of the image display element 10. Numbers 1 and 2 in Table 1 indicate the respective surfaces of the cover glass included in the image display element 10.

The cover glass is a glass plate that covers the image display surface of the image display element 10.

Numbers 3 to 14 in Table 1 correspond to the optical path from the propagation optical system 20 to the reflecting surface of the reflector 40. Numbers from 15 onward in Table 1 correspond to the optical path from the reflecting surface of the reflector 40 to the eye EY.

The mark “A” in the interval D column for No. 17 in Table 1 indicates the distance between the reflecting surface of the reflector 40 and each partial reflector 320 (partial reflection surface) along the optical axis AX. For convenience, the distance interval is referred to as interval A. The interval A is 13.2 mm, 14.8 mm, 16.4 mm, 18.0 mm, 19.6 mm, 21.2 mm, and 22.8 mm in order from the partial reflector 320 closest to the reflecting surface of the reflector 40. In other words, the seven partial reflectors 320 are disposed at equal intervals of 1.6 mm.

Table 1 for Numerical Example 1

| | Ry | Rx | D | Nd | ν d | | |
|---|---|---|---|---|---|---|---|
| 0 | ∞ | ∞ | 0.00 | | | | |
| 1 | ∞ | ∞ | 0.30 | 1.51633 | 84.14 | | S-BSL7(OHARA) |
| 2 | ∞ | ∞ | 0.44 | | | | |
| 3* | 7.121 | 13.040 | 1. [symbol] 7 | 1.83200 | 23 | | OKP4HT(Osaka Gas Chemicals) |
| 4* | 3.7 [symbol] 8 | −20.502 | 1.2 [symbol] | | | | |
| 5* | −18.616 | 14.074 | 3.28 | 1.53100 | 56 | | E48R(ZEON) |
| 6* | −11.258 | −7. [symbol] 47 | 6.40 | | | | |
| 7* | 9.968 | 5. [symbol] 8 | 3.34 | 1.53100 | 56 | | E48R(ZEON) |
| 8* | −10.450 | −15.964 | 0.00 | | | | |
| 9 | STOP | | 0.40 | | | | |
| 10* | −5.011 | 41.194 | 1.21 | 1.83200 | 23 | | OKP4HT(Osaka Gas Chemicals) |
| 11* | −25.0 [symbol] 1 | 7.806 | 1.54 | | | | |
| 12* | 4.959 | 8.718 | 36.58 | 1.53100 | 56 | | E48R(ZEON) |
| 13* | −4.475 | −53.379 | 3.84 | | | | |
| 14* | −4.87 [symbol] | −19.428 | 1.500 | 1.53100 | 56 | REFLECTION | E48R(ZEON) |
| 15* | −29.831 | −31.910 | −1.50 | 1.53100 | 56 | | E48R(ZEON) |
| 16* | −4.678 | −19.428 | −3.84 | | | | |
| 17* | −4.47 [symbol] | −53.37 [symbol] | A | 1.53100 | 56 | | E48R(ZEON) |
| 18 | ∞ | ∞ | 2.500 | 1.53100 | 56 | REFLECTION | E48R(ZEON) |
| 19 | ∞ | ∞ | 15.00 | | 56 | | |

[symbol]

indicates data missing or illegible when filed

In Table 1, the surfaces marked with “*” represent aspherical surfaces. More specifically, these aspherical surfaces are anamorphic aspherical surfaces having an anamorphic power. Table 2 is a list of data of each aspherical surface. In Table 2, the capital letter “E” represents a power in which 10 is the base and the number on the right of E is an exponent. The radius of curvature R of the aspherical surface is represented by a radius of curvature (paraxial radius of curvature) along the optical axis AX. The aspherical shape is given by the following equation, where Z is a sag amount, C is a paraxial radius of curvature (1/R), h is a height from the optical axis AX (mm), K is a conic constant, and A4, A6, are aspherical coefficients of even orders equal to or higher than the fourth order.

Z=Ch²/{1+√(1−(1+k)c²h²)}a⁴·h⁴+a⁶·h⁶+a⁸·h⁸+a¹⁰·h¹⁰

Further, the shape of the anamorphic aspherical surface satisfies the following equation where Cx is a paraxial radius of curvature (1/Rx) in the x-axis, Cy is a paraxial radius of curvature in the y-axis, X (mm) is the height in the x-axis from the optical axis AX, Kx is the conic constant in the x-axis, Ky is the conic coefficient in the y-axis, AR4, AR6, are even-numbered coefficients of rotational symmetry equal to or higher than the fourth order, and AP4, AP6, are even-numbered coefficients of rotational asymmetry equal to or higher than the fourth order.

Z=(CxX²+CyY²)/{1+√(1−(1+Kx)Cx²X²−(1+Ky)Cy²Y²)}+AR₄((1−AP₄)X²+(1+Ap₄)—Y₂)₂+AR₆((1−AP₆)X²+(1+AP6)Y²)³+AR₈((1−AP₈)X²+(1+AP₈)Y²)⁴+AR₁₀·((1−AP₁₀)X²+(1+AP₁₀)Y²)⁵

The description format of the Table is the same in the following Numerical Example 2 to Numerical Example 4.

TABLE 2
Conic coefficient

| | Ky | Kx |
|---|---|---|
| 3 | 0.000 | 0.516 |
| 4 | 0.000 | 0.000 |
| 5 | 0.000 | −15.811 |
| 6 | 0.000 | −9.908 |
| 7 | 0.000 | −0.341 |
| 8 | 7.360 | 0.843 |
| 10 | 0.000 | 0.000 |
| 11 | 0.000 | 0.000 |
| 12 | −1.884 | 0.259 |
| 13 | −0.256 | −10.000 |
| 14 | −0.278 | −0.500 |
| 15 | 0.000 | 0.000 |
| 16 | −0.278 | −0.500 |
| 17 | −0.256 | −10.000 |

Coefficient of rotational symmetry

| | AR₄ | AR₆ | AR₈ | AR₁₀ |
|---|---|---|---|---|
| 3 | −7.76323E−03 | −9.51252E−06 | 4.09087E−06 | 7.23929E−13 |
| 4 | −1.08531E−02 | −1.43957E−05 | −1.41519E−04 | 1.87999E−05 |
| 5 | −6.91645E−03 | 2.98692E−04 | −5.07347E−04 | 2.61763E−07 |
| 6 | −1.88451E−03 | 1.54666E−04 | −8.34437E−06 | 1.87228E−07 |
| 7 | −1.24619E−04 | 9.51852E−07 | 1.23104E−05 | 8.01861E−09 |
| 8 | −1.56118E−03 | 5.52015E−05 | −1.40626E−07 | −5.79061E−07 |
| 10 | −3.28106E−04 | −2.06328E−04 | 2.15997E−05 | 1.68583E−08 |
| 11 | −2.86968E−04 | 3.92888E−08 | −1.05107E−05 | 4.93831E−06 |
| 12 | −1.62250E−03 | 5.83717E−05 | −8.11627E−08 | 2.55278E−07 |
| 13 | 2.93591E−08 | 1.02428E−05 | 1.11223E−10 | 2.82803E−08 |
| 14 | −1.29768E−06 | 1.84465E−05 | 1.14804E−11 | 1.04617E−06 |
| 15 | −4.09496E−06 | −1.85028E−08 | 1.28010E−10 | −7.20324E−13 |
| 16 | −1.29768E−06 | 1.84465E−05 | 1.14804E−11 | 1.04617E−06 |
| 17 | 2.93591E−08 | 1.02428E−05 | 1.11223E−10 | 2.82803E−08 |

Rotational asymmetry coefficient

| | AP₄ | AP₆ | AP₈ | AP₁₀ |
|---|---|---|---|---|
| 3 | 1.19630E−01 | −6.94471E−01 | −3.53908E−01 | −1.33206E+01 |
| 4 | 8.47243E−01 | 1.90423E+00 | 1.30206E+00 | 1.27887E+00 |
| 5 | 7.99103E−01 | 7.35097E−01 | 9.62117E−01 | 3.55081E−01 |
| 6 | −2.68841E−01 | −4.91645E−02 | 2.65334E−02 | 2.28358E−02 |
| 7 | −7.85875E−01 | 2.14649E+00 | 9.54031E−01 | −1.56432E−01 |
| 8 | 2.361666−01 | 6.96725E−02 | 2.37405E+00 | 1.41869E+00 |
| 10 | −5.77476E−01 | 7.48724E−01 | 6.07359E−01 | 1.96399E+00 |
| 11 | 1.23526E+00 | 7.76237E+00 | 1.21748E+00 | 6.91632E−01 |
| 12 | 1.191178−01 | 3.37799E−01 | −9.85168E−01 | 1.01347E+00 |
| 13 | 1.18977E+01 | 1.10488E+00 | −4.59784E−01 | 9.19629E−01 |
| 14 | −1.30332E+00 | 8.87715E−01 | −1.60782E+00 | 1.02959E+00 |
| 15 | 6.15069E−01 | 5.32757E−02 | −6.82793E−02 | 8.36410E−02 |
| 16 | −1.30332E+00 | 8.87715E−01 | −1.60782E+00 | 1.02959E+00 |
| 17 | 1.18977E+01 | 1.10488E+00 | −4.59784E−01 | 9.19629E−01 |

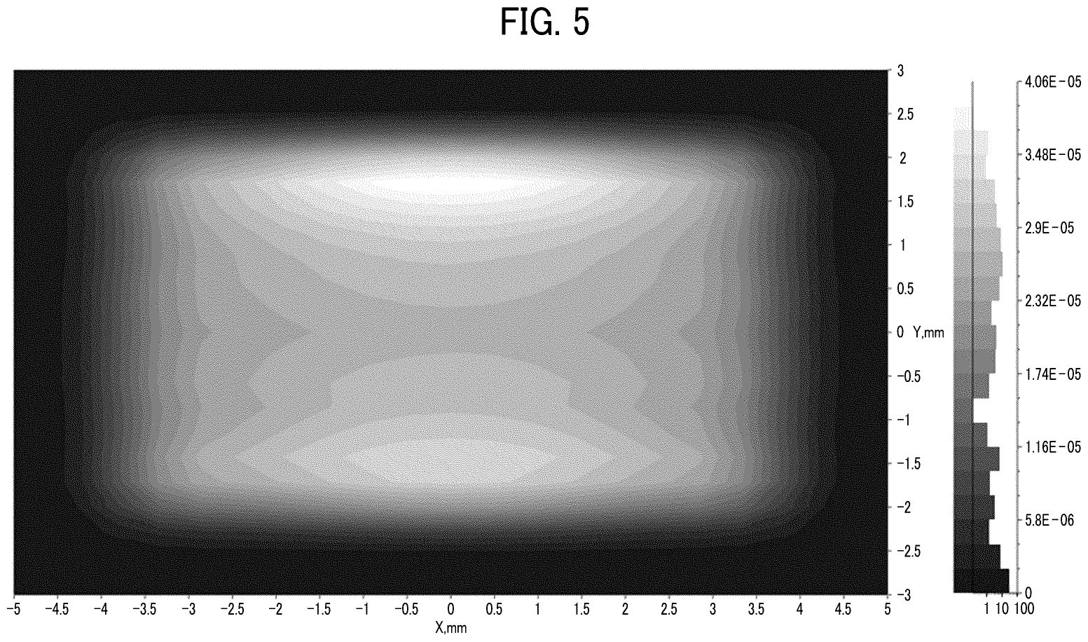

FIG. 5 is a diagram of the illuminance distribution on the wearer's retina in Numerical Example 1. The simulation diagram in FIG. 5 indicates the illuminance distribution when the pupil diameter of the eye EY is 2.5 mm and the eye relief is 15 mm. The illuminance distribution is calculated for the case of forming an image with an ideal lens having a focal length of 12 mm. The simulation diagram represents the projection of light with an angle of view of 35 degrees (horizontal)×20 degrees (vertical).

A similar simulation was conducted with the eye EY positioned 500 mm away from the face 350 of the light guide 30. In other words, the illuminance distribution on the retina of a third party near the wearer was calculated. It was found from the simulation results that the illuminance on the retina of a third party is only 0.078% of the level of the illuminance on the retina of the wearer. This indicates that Numerical Example 1 minimizes the amount of image light that reflects off the partial reflector 320 and leaks to the outside from the face 350.

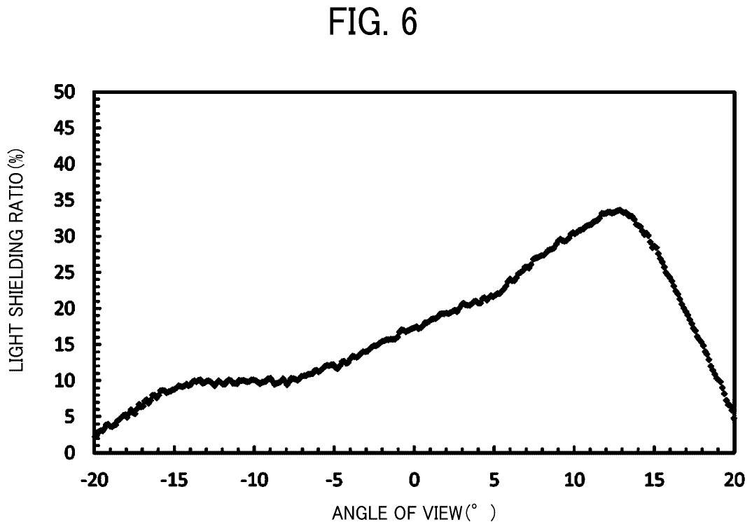

FIG. 6 is a graph of light shielding ratios in Numerical Example 1. In FIG. 6, the vertical axis indicates the light shielding ratio (unit: %), and the horizontal axis indicates the angle of view (unit: degrees). The light shielding ratio is determined by the following equation.

Light shielding ratio=(illuminance LD1−illuminance LD2|/illuminance LD1)×100

Illuminance LD1 Illuminance LD1 is the illuminance on the retina for a certain angle of view when a wearer views a light source placed at a sufficient distance from the virtual image display device 1A through a virtual image display device that does not include the partial reflector 320. Illuminance LD2 Illuminance LD2 is the illuminance on the retina for the above angle of view when a wearer views a light source placed at the above distance from the virtual image display device 1A through a virtual image display device that includes the partial reflector 320.

It is found from FIG. 6 that Numerical Example 1 also maintains at a low level, a decrease in the see-through property due to the arrangement of the partial reflectors 320 within the field of view.

### Numerical Example 2

The virtual image display device 1A according to Numerical Example 2 has a similar configuration to that of the virtual image display device 1A according to Numerical Example 1 except that the reflectance of the partial reflector 320 is different from that of the virtual image display device 1A according to Numerical Example 1.

In Numerical Example 2, the reflectance for the P-polarized light (the light polarized in the first polarization direction) of the partial reflectors 320 are 1%, 1%, 1%, 2%, 2%, 3%, and 5% in order from the partial reflector 320 closest to the polarizing plate 60 among the partial reflectors 320.

In Numerical Example 2, the reflectance for the S-polarized light (the light polarized in the second polarization direction) of the partial reflectors 320 are 10%, 11%, 12%, 18%, 23%, 29%, and 42% in order from the partial reflector 320 closest to the polarizing plate 60 among the partial reflectors 320.

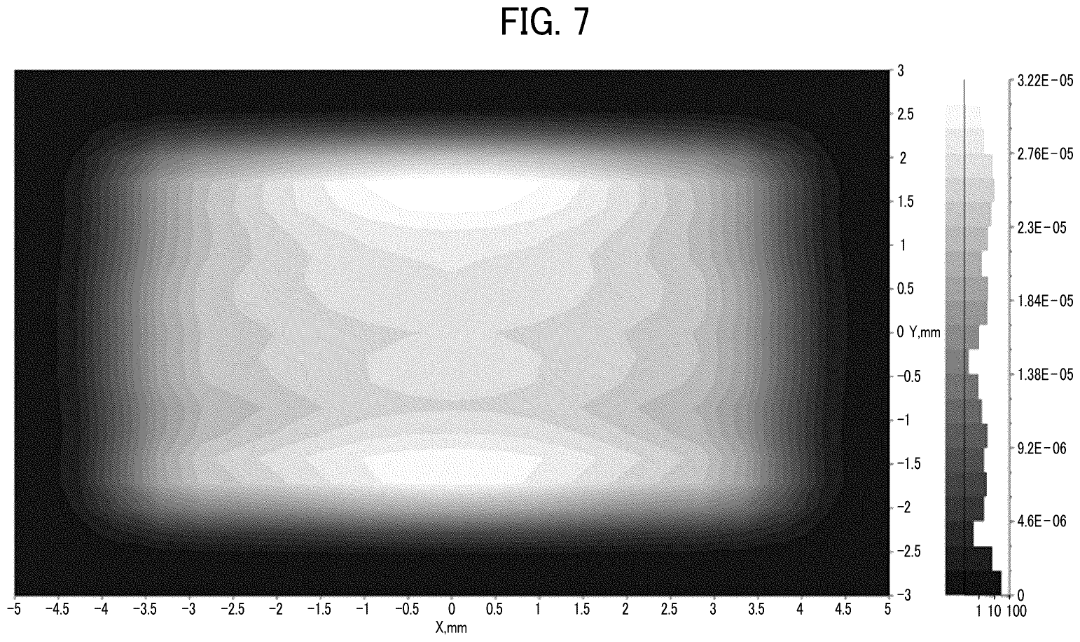

Similarly to FIG. 5, FIG. 7 is a diagram of the illuminance distribution on the wearer's retina in Numerical Example 2. The simulation diagram in FIG. 7 indicates the illuminance distribution when the pupil diameter of the eye EY is 2.5 mm and the eye relief is 15 mm. The illuminance distribution is calculated for the case of forming an image with an ideal lens having a focal length of 12 mm. The simulation diagram represents the projection of light with an angle of view of 35 degrees (horizontal)×20 degrees (vertical).

A similar simulation was conducted with the eye EY positioned 500 mm away from the face 350 of the light guide 30. It was found from the simulation results that the illuminance on the retina of a third party is only 0.04% of the level of the illuminance on the retina of the wearer. This indicates that Numerical Example 2 minimizes the amount of image light that reflects off the partial reflector 320 and leaks to the outside from the face 350.

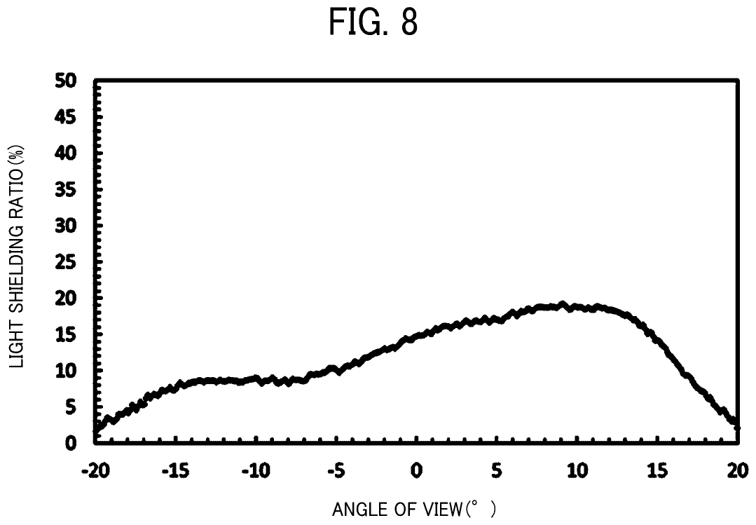

Similarly to FIG. 6, FIG. 8 is a graph of light shielding ratios in Numerical Example 2. It is found from FIG. 8 that Numerical Example 2 also maintains at a low level, a decrease in the see-through property due to the arrangement of the partial reflectors 320 within the field of view.

### Numerical Example 3

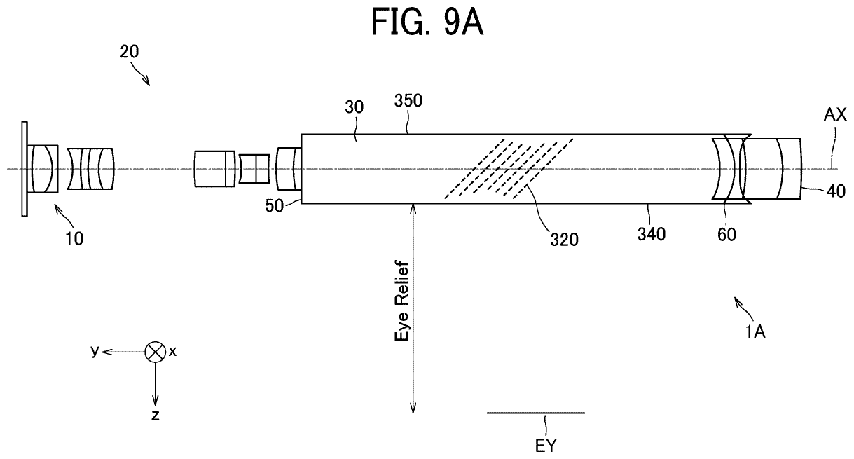

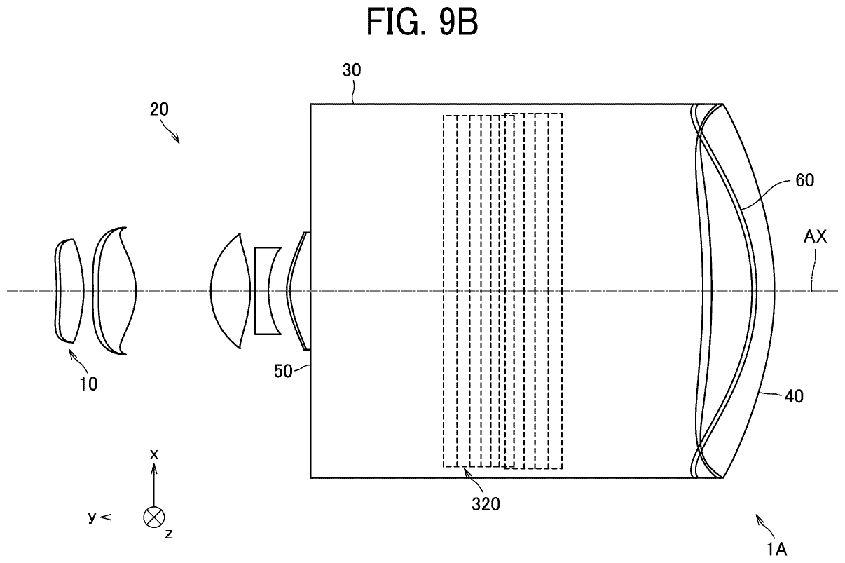

FIGS. 9A and 9B illustrate the optical configuration of the virtual image display device 1A according to Numerical Example 3. The virtual image display device 1A according to Numerical Example 3 has a similar configuration to that of the virtual image display device 1A according to Numerical Example 1 except that the following four parameters are different from those of the virtual image display device 1A according to Numerical Example 1.

(1) Side length L1 of the partial reflector 320 (2) Reflectance of the partial reflector 320 (3) Interval A between the partial reflectors 320 (4) A polarizing film is formed on the first face 310 of the light guide 30 instead of the polarizing plate 50.

In Numerical Example 3, the side lengths L1 of the partial reflectors 320 are 7 mm, 6 mm, 5.5 mm, 5 mm, 5.5 mm, 6 mm, and 7 mm, respectively, in order from a partial reflector 320 closest to the polarizing plate 60 among the partial reflectors 320.

In Numerical Example 3, the reflectance for the P-polarized light (the light polarized in the first polarization direction) of the partial reflectors 320 are 1%, 1%, 1%, 2%, 2%, 3%, and 5% in order from the partial reflector 320 closest to the polarizing plate 60 among the partial reflectors 320.

In Numerical Example 3, the reflectance for the S-polarized light (the light polarized in the second polarization direction) of the partial reflectors 320 are 10%, 11%, 12%, 18%, 23%, 29%, and 42% in order from the partial reflector 320 closest to the polarizing plate 60 among the partial reflectors 320.

The interval A is 15.3 mm, 16.2 mm, 17.1 mm, 18.0 mm, 18.9 mm, 19.8 mm, and 20.7 mm in order from the partial reflector 320 closest to the reflecting surface of the reflector 40. In other words, the seven partial reflectors 320 are disposed at equal intervals of 0.9 mm.

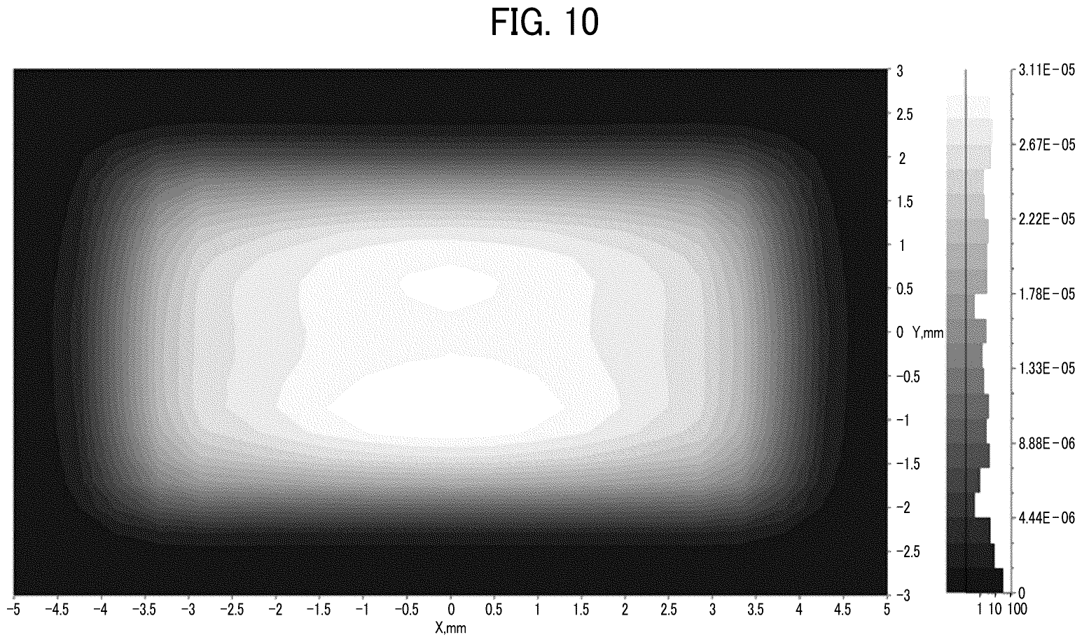

Similarly to FIG. 5, FIG. 10 is a diagram of the illuminance distribution on the wearer's retina in Numerical Example 3. The simulation diagram in FIG. 10 indicates the illuminance distribution when the pupil diameter of the eye EY is 2.5 mm and the eye relief is 15 mm. The illuminance distribution is calculated for the case of forming an image with an ideal lens having a focal length of 12 mm. The simulation diagram represents the projection of light with an angle of view of 35 degrees (horizontal)×20 degrees (vertical).

A similar simulation was conducted with the eye EY positioned 500 mm away from the face 350 of the light guide 30. It was found from the simulation results that the illuminance on the retina of a third party is only 0.3% of the level of the illuminance on the retina of the wearer. This indicates that Numerical Example 3 minimizes the amount of image light that reflects off the partial reflector 320 and leaks to the outside from the face 350.

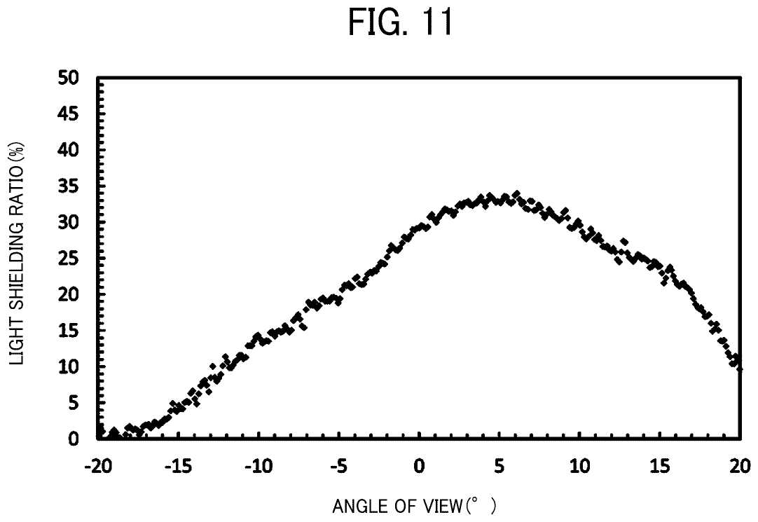

Similarly to FIG. 6, FIG. 11 is a graph of light shielding ratios in Numerical Example 3. It is found from FIG. 11 that Numerical Example 3 also maintains at a low level, a decrease in the see-through property due to the arrangement of the partial reflectors 320 within the field of view.

### Numerical Example 4

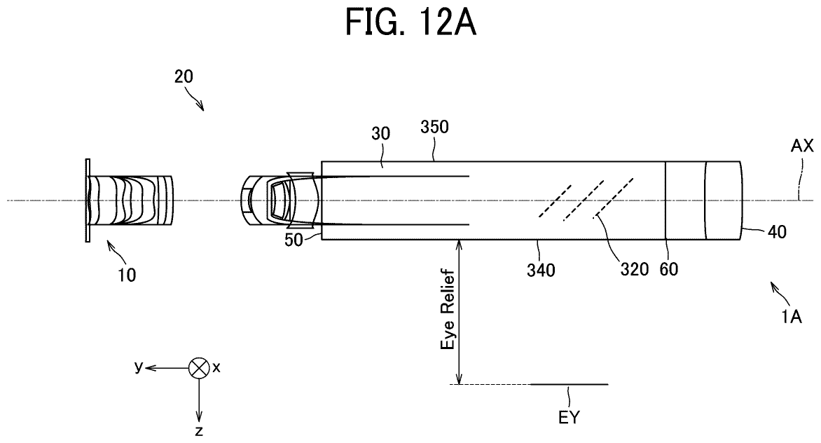

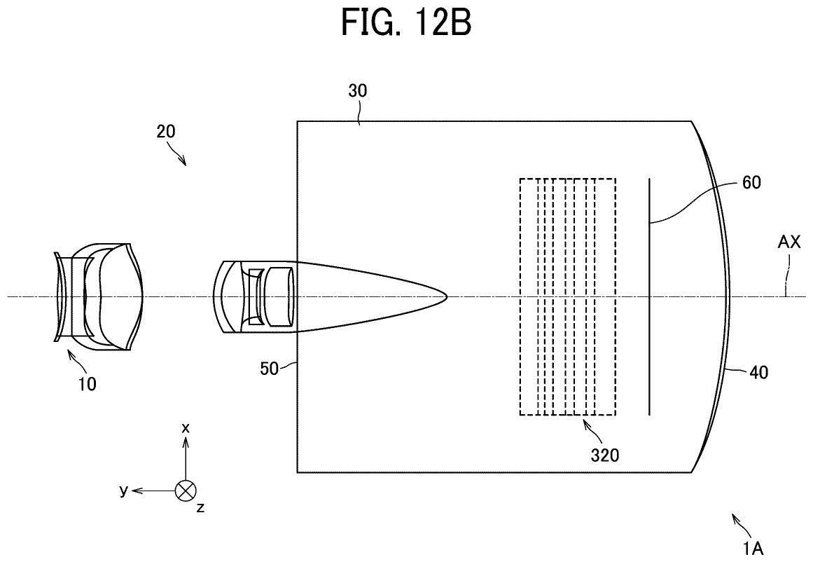

FIGS. 12A and 12B illustrate the optical configuration of the virtual image display device 1A according to Numerical Example 4.

The virtual image display device 1A according to Numerical Example 4 includes a propagation optical system as the intermediate image former 20. The polarizing plate 50 is disposed in front of the light guide 30. The light guide 30 has a thickness of 6 mm. In the light guide 30, three partial reflectors 320 formed in a planar shape are arranged at intervals d of 2.5 mm. A quarter-wave plate serving as the polarizing plate 60 is disposed in the light guide 30. FIGS. 12A and 12B, the optical element surface located furthest in the —Y-direction is the reflecting surface of the reflector 40.

In Numerical Example 4, the angles of view of the virtual image in the vertical direction, the horizontal direction, and the diagonal direction are 17.5 degrees, 28.9 degrees, and 31.4 degrees, respectively. The distance to the virtual image is infinite. The aperture stop has a rectangular aperture with a length of 2.0 mm in the vertical direction and a length of 5.6 mm in the horizontal direction.

In Numerical Example 4, the side lengths L1 of the partial reflectors 320 are 5 mm, 5 mm, and 4 mm, respectively, in order from a partial reflector 320 closest to the polarizing plate 60 among the partial reflectors 320.

In Numerical Example 4, the reflectance for the P-polarized light (the light polarized in the first polarization direction) of the partial reflectors 320 are 5%, 4%, and 4% in order from the partial reflector 320 closest to the polarizing plate 60 among the partial reflectors 320.

In Numerical Example 4, the reflectance for the S-polarized light (the light polarized in the second polarization direction) of the partial reflectors 320 are 21%, 29%, and 29% in order from the partial reflector 320 closest to the polarizing plate 60 among the partial reflectors 320.

Tables 3 and 4 present a specific numerical configuration and data for each aspherical surface of the virtual image display device 1A according to Numerical Example 4.

In Table 3, number 0 indicates an image display surface of the image display element 10. Numbers 1 and 2 in Table 3 indicate the respective surfaces of the cover glass included in the image display element 10. Numbers 3 to 15 in Table 3 correspond to the optical path from the propagation optical system 20 to the reflecting surface of the reflector 40. Numbers from 16 onward in Table 3 correspond to the optical path from the reflecting surface of the reflector to the eye EY.

The interval A is 11.5 mm, 14.0 mm, and 16.5 mm in order from the partial reflector 320 closest to the reflecting surface of the reflector 40. In other words, the three partial reflectors 320 are disposed at equal intervals of 2.5 mm.

Table 3 for Numerical Example 4

| | Ry | Rx | D | Nd | ν d | | |
|---|---|---|---|---|---|---|---|
| 0 | ∞ | ∞ | 0.00 | | | z | |
| 1 | ∞ | ∞ | 0.30 | 1.51633 | 64.14 | | S-BSL7(OHARA) |
| 2 | ∞ | ∞ | 0.80 | | | | |
| 3* | 7.293 | −7.380 | 1.3 [symbol] | 1.83200 | 23 | | OKP4HT(Osaka Gas Chemicals) |
| 4* | 3.294 | 5.5 [symbol] | 1.52 | | | | |
| 5* | 47.937 | 28.858 | 3.63 | 1.53100 | 56 | | E48R(ZEON) |
| 6* | −19.724 | −7.485 | 5.99 | | | | |
| 7* | 3.85 [symbol] | 5.799 | 2. [symbol] | 1.53100 | 56 | | E48R(ZEON) |
| 8* | 43.492 | −15.861 | 0.00 | | | | |
| 9 | STOP | | 0.3 [symbol] | | | | |
| 10* | −2. [symbol] 04 | 130.060 | 0.90 | 1.83200 | 23 | | OKP4HT(Osaka Gas Chemicals) |
| 11* | −8.011 | 8.706 | 0.43 | | | | |
| 12* | 120.2 [symbol] | 5.957 | 2.53 | 1.53100 | 56 | | E48R(ZEON) |
| 13* | −4.077 | −23.881 | 0.00 | | | | |
| 14 | ∞ | ∞ | 37.00 | 1.53100 | 5 [symbol] | | E48R(ZEON) |
| 15* | −33.804 | −42.228 | A | 1.53100 | 5 [symbol] | REFLECTION | E48R(ZEON) |
| 16 | ∞ | ∞ | 3.00 | 1.53100 | 5 [symbol] | REFLECTION | E48R(ZEON) |
| 17 | ∞ | ∞ | 15.000 | | | | |

[symbol]

indicates data missing or illegible when filed

TABLE 4
Conic coefficient

| | Ky | Kx |
|---|---|---|
| 3 | 0.000 | 0.000 |
| 4 | 0.000 | 0.000 |
| 5 | 0.000 | 0.000 |
| 6 | −56.929 | −11.406 |
| 7 | 0.751 | −0.102 |
| 8 | 0.000 | 0.000 |
| 10 | 0.000 | 0.000 |
| 11 | 0.000 | 0.000 |
| 12 | −292.967 | 0.560 |
| 13 | 0.000 | 0.000 |
| 15 | 0.000 | 0.000 |

Coefficient of rotational symmetry

| | AR₄ | AR₆ | AR₈ | AR₁₀ |
|---|---|---|---|---|
| 3 | −9.16833E−03 | 2.85687E−05 | 7.45172E−06 | −3.43737E−10 |
| 4 | −1.29126E−02 | 1.26525E−05 | −1.85831E−04 | 1.89301E−05 |
| 5 | −1.40887E−03 | 3.70392E−08 | −2.96121E−04 | 6.53424E−08 |
| 6 | −2.52313E−03 | 1.50391E−04 | −1.06850E−05 | 2.32247E−07 |
| 7 | 7.18750E−05 | −6.26413E−05 | −3.37204E−06 | −4.35367E−08 |
| 8 | −1.43478E−04 | −4.04819E−05 | 8.43663E−07 | 1.01250E−04 |
| 10 | −6.65868E−04 | −1.44345E−06 | 1.13479E−06 | 2.12897E−04 |
| 11 | 3.07672E−06 | −6.24423E−05 | −9.28174E−07 | −3.57756E−10 |
| 12 | −2.05319E−03 | −3.79664E−05 | −2.88095E−07 | −8.03168E−10 |
| 13 | 1.06905E−03 | 4.31995E−08 | −1.10909E−13 | 5.63771E−07 |
| 15 | −5.58376E−07 | −2.94573E−09 | 1.77413E−10 | −1.77399E−11 |

Rotational asymmetry coefficient

| | AR₄ | AR₆ | AR₈ | AR₁₀ |
|---|---|---|---|---|
| 3 | 8.68047E−01 | −8.82157E−01 | 1.55260E−01 | −5.08834E+00 |
| 4 | 7.31462E−01 | 3.47234E+00 | 1.26008E+00 | 1.21305E+00 |
| 5 | 9.56024E−01 | 5.18821E+00 | 9.81824E−01 | −5.47977E−01 |
| 6 | −2.20941E−02 | −4.56212E−02 | −3.43205E−02 | −1.11731E−01 |
| 7 | 2.98221E+00 | 2.83071E−01 | 1.75489E+00 | −2.19855E−01 |
| 8 | −5.88288E−01 | 1.74630E−01 | 2.03094E+00 | 1.30131E+00 |
| 10 | −3.37768E−02 | −9.76577E−02 | 2.54320E+00 | 1.31166E+00 |
| 11 | −1.08382E+01 | 1.66250E+00 | 2.44901E+00 | 4.42657E+00 |
| 12 | 2.77249E−01 | 1.60853E+00 | −2.08693E+00 | 5.59192E+00 |
| 13 | 1.12454E−01 | −4.47353E+00 | −7.47735E+01 | 1.33450E+00 |
| 15 | 2.15817E+00 | 2.46811E−01 | −2.05655E−01 | 4.74513E−01 |

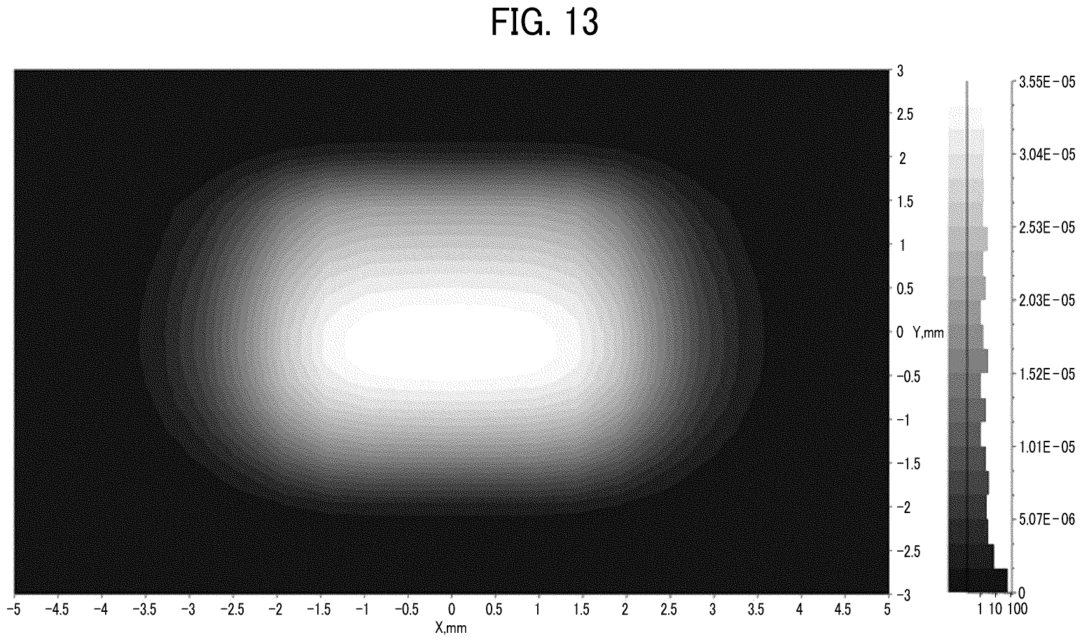

Similarly to FIG. 5, FIG. 13 is a diagram of the illuminance distribution on the wearer's retina in Numerical Example 4. The simulation diagram in FIG. 13 indicates the illuminance distribution when the pupil diameter of the eye EY is 2.5 mm and the eye relief is 15 mm. The illuminance distribution is calculated for the case of forming an image with an ideal lens having a focal length of 12 mm. The simulation diagram represents the projection of light with an angle of view of 29 degrees (horizontal)×17 degrees (vertical).

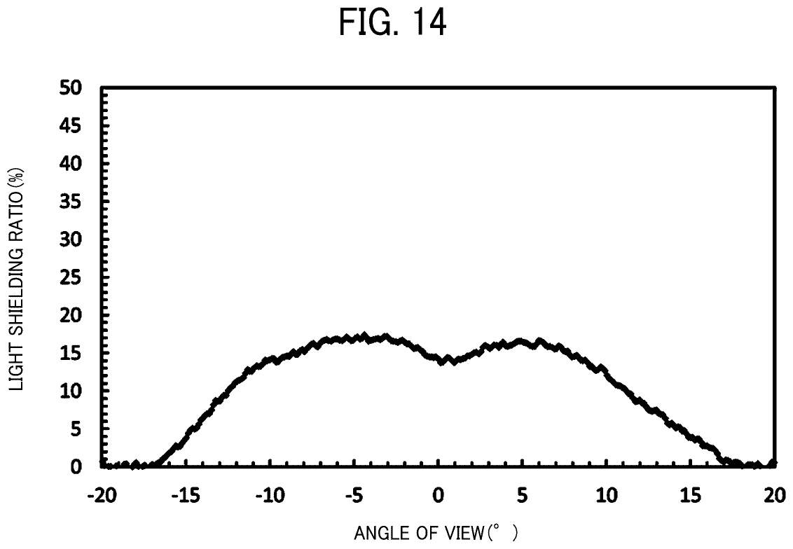

A similar simulation was conducted with the eye EY positioned 500 mm away from the face 350 of the light guide 30. It was found from the simulation results that the illuminance on the retina of a third party is only 1.3% of the level of the illuminance on the retina of the wearer. This indicates that Numerical Example 4 minimizes the amount of image light that reflects off the partial reflector 320 and leaks to the outside from the face 350. Similarly to FIG. 6, FIG. 14 is a graph of light shielding ratios in Numerical Example 4. It is found from FIG. 14 that Numerical Example 4 also maintains at a low level, a decrease in the see-through property due to the arrangement of the partial reflectors 320 within the field of view.

The above is a description of embodiments of the present disclosure. The embodiments of the present invention are not limited to those described above, and various modifications are possible within the scope of the technical idea of the present invention. For example, the embodiments of the present application also include contents obtained by appropriately combining the embodiments explicitly described in the specification or the obvious embodiments.

Hereinafter, the invention described in the claims at the beginning of the application will be additionally described.

Aspect 1

An optical system for a virtual display device includes: a light guide to guide image light emitted from an image display element that displays an image; a partial reflector to: transmit first image light guided in a first direction from a first side of the partial reflector through the light guide; and reflect second image light to exit outside the light guide, the second image light guided in a second direction, different from the first direction, from a second side different from the first side through the light guide; a reflector at the second side of the partial reflector to reflect the first image light transmitted through the partial reflector in the first direction, back to the partial reflector as the second image light in the second direction; and a polarizer between the partial reflector and the reflector. The polarizer rotates a polarization of the first image light polarized in a first polarization direction, the first image light transmitted through the partial reflector in the first direction; and rotates a polarization of the second image light reflected back from the reflector to polarize the second image light in a second polarization direction. The partial reflector has a lower reflectance for light polarized in the first polarization direction than for light polarized in the second polarization direction.

Aspect 2

The optical system for the virtual display device according to Aspect 1, further includes multiple partial reflectors including the partial reflector. The multiple partial reflectors are disposed at intervals along an optical axis of the optical system.

Aspect 3

In the optical system for the virtual display device according to Aspect 2, conditional expression below is satisfied: 0.5 mm<d<3.0 mm where d is each of the intervals between the multiple partial reflectors arranged along the optical axis.

Aspect 4

In the optical system for the virtual display device according to Aspect 2 or 3, the multiple partial reflectors include: a first partial reflector; and a second partial reflector positioned farther from the polarizer than the first partial reflector along the optical axis in the second direction. Conditional expression below is satisfied: R1<R2 where R1 is a reflectance of the first partial reflector for the light polarized in the second polarization direction, and R2 is a reflectance of the second partial reflector for the light polarized in the second polarization direction.

Aspect 5

The optical system for the virtual display device according to any one of Aspect 1 to Aspect 4, the partial reflector includes a partial reflection surface formed in a plane.

Aspect 6

In the optical system for the virtual display device according to any one of Aspect 1 to Aspect 5, the partial reflector has a reflectance of 5% or more and 50% or less for the light polarized in the second polarization direction.

Aspect 7

In the optical system for the virtual display device according to any one of Aspect 1 to Aspect 6, the partial reflector has a reflectance of 25% or less for the light polarized in the first polarization direction.

Aspect 8

The optical system for the virtual display device according to any one of Aspect 1 to Aspect 7, a side length of the partial reflector, along a side face of the light guide, is 0.3 times or more and 1.5 times or less than a length of the side face in a lateral direction orthogonal to a longitudinal direction of the side face.

In other words, the light guide has: a first face through which the image light emitted from the image display element enters the light guide; a second face opposite to the first face with the partial reflector between the first face and the second face; and a third face from which the image light guided in the light guide exits the light guide. The partial reflection surface of the partial reflector has the plane inclined with respect to a thickness direction of the light guide, the thickness direction of the light guide being defined by a distance between the third face and a surface facing the third face. A length of the partial reflection surface is 0.3 times or more and 1.5 times or less than a length of the light guide in the thickness direction.

Aspect 9

In the optical system for the virtual display device according to any one of Aspect 1 to Aspect 9, the reflector has a positive power.

Aspect 10

The optical system for the virtual display device according to any one of Aspect 1 to Aspect 9, further includes another polarizer between the image display element and the partial reflector. Said another polarizer converts the first image light guided in the first direction from the first side of the partial reflector toward the partial reflector, into the light polarized in the first polarization direction. In other words, said another polarizer polarizes the first image light, guided in the first direction from the first side to the partial reflector, in the first polarization direction

Aspect 11

The optical system for the virtual display device according to any one of Aspect 1 to Aspect 9, further includes a polarizing film on a surface of an optical element between the image display element and the partial reflector. The polarizing film converts the first image light guided in the first direction from the first side of the partial reflector toward the partial reflector, into the light polarized in the first polarization direction. In other words, the polarizing film polarizes the first image light, to be guided in the first direction from the first side to the partial reflector, in the first polarization direction.

Aspect 12

The optical system for the virtual display device according to any one of Aspect 1 to Aspect 11, further includes a propagation optical system to transmit the image light emitted from the image display element to the light guide and form an intermediate image of the image light within the light guide.

Aspect 13

A virtual image display device includes: the image display element; and the optical system for the virtual display device according to any one of Aspect 1 to Aspect 12.

Aspect 14

A head-mounted display includes the virtual image display device according to Aspect 13.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

1. An optical system comprising:
a light guide to guide image light emitted from an image display element that displays an image;
a partial reflector to:
transmit first image light guided in a first direction from a first side of the partial reflector through the light guide; and
reflect second image light to exit outside the light guide, the second image light guided in a second direction, different from the first direction, from a second side different from the first side through the light guide;
a reflector at the second side of the partial reflector to reflect the first image light transmitted through the partial reflector in the first direction, back to the partial reflector as the second image light in the second direction; and
a polarizer between the partial reflector and the reflector to:
rotate a polarization of the first image light polarized in a first polarization direction, the first image light transmitted through the partial reflector in the first direction; and
rotate a polarization of the second image light reflected back from the reflector to polarize the second image light in a second polarization direction,
wherein the partial reflector has a lower reflectance for light polarized in the first polarization direction than for light polarized in the second polarization direction.

2. The optical system according to claim 1, further comprising multiple partial reflectors including the partial reflector,
wherein the multiple partial reflectors are disposed at intervals along an optical axis of the optical system.

3. The optical system according to claim 2,
wherein conditional expression below is satisfied:
0.5 mm<d<3.0 mm
where
d is each of the intervals between the multiple partial reflectors arranged along the optical axis.

4. The optical system according to claim 2,
wherein the multiple partial reflectors include:
a first partial reflector; and
a second partial reflector positioned farther from the polarizer than the first partial reflector along the optical axis in the second direction,
conditional expression below is satisfied:
R1<R2
where:
R1 is a reflectance of the first partial reflector for the light polarized in the second polarization direction; and
R2 is a reflectance of the second partial reflector for the light polarized in the second polarization direction.

5. The optical system according to claim 1,
wherein the partial reflector includes a partial reflection surface formed in a plane.

6. The optical system according to claim 1,
wherein the partial reflector has a reflectance of 5% or more and 50% or less for the light polarized in the second polarization direction.

7. The optical system according to claim 1,
wherein the partial reflector has a reflectance of 25% or less for the light polarized in the first polarization direction.

8. The optical system according to claim 5,
wherein the light guide has:
a first face through which the image light emitted from the image display element enters the light guide;
a second face opposite to the first face with the partial reflector between the first face and the second face; and
a third face from which the image light guided in the light guide exits the light guide,
the partial reflection surface of the partial reflector has the plane inclined with respect to a thickness direction of the light guide, the thickness direction of the light guide being defined by a distance between the third face and a surface facing the third face, and
a length of the partial reflection surface is 0.3 times or more and 1.5 times or less than a length of the light guide in the thickness direction.

9. The optical system according to claim 1,
wherein the reflector has a positive power.

10. The optical system according to claim 1, further comprising another polarizer between the image display element and the partial reflector,
wherein said another polarizer polarizes the first image light, guided in the first direction from the first side to the partial reflector, in the first polarization direction.

11. The optical system according to claim 1, further comprising a polarizing film on a surface of an optical element between the image display element and the partial reflector,
wherein the polarizing film polarizes the first image light, to be guided in the first direction from the first side to the partial reflector, in the first polarization direction.

12. The optical system according to claim 1, further comprising a propagation optical system to:
transmit the image light emitted from the image display element to the light guide; and
form an intermediate image of the image light within the light guide.

13. A virtual image display device comprising:
the optical system according to claim 1; and
the image display element.

14. A head-mounted display comprising the virtual image display device according to claim 13.
